(19) United States
(12) Patent Application Publication
(10) Pub. No.: US 2006/0116912 A1
(43) Pub. Date: Jun. 1, 2006

(54) Managing account-holder information using policies

(75) Inventor: Stephane H. Maes, Fremont, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 11/123,468

(22) Filed: May 5, 2005

Related U.S. Application Data
(60) Provisional application No. 60/632,632, filed on Dec. 1, 2004.

(51) Int. Cl. G06Q 40/00

(52) U.S. Cl. 705/4

(57) ABSTRACT

Methods, systems, and machine-readable mediums are disclosed for managing account-holder information using policies. In one embodiment, the method comprises receiving service agreement information for an account-holder and generating a policy using the service agreement information. The policy includes a logical combination of one or more conditions to be satisfied and one or more actions to be executed related to the service agreement information

### CROSS-REFERENCES TO RELATED APPLICATIONS

This application claims the benefit of U.S. Provisional Application No. 60/632,632, entitled “Managing Customer Information Using Policies”, filed Dec. 1, 2004, which is incorporated herein by reference.

### BACKGROUND OF THE INVENTION

A Customer Relationship Management (CRM) application may be used by a company to help the company manage information about customers, vendors, partners, or other entity or person doing business with the company. The CRM application may include features that allow a customer, partner, or vendor to be associated with a profile and data. For example, the profile may include services subscribed to by the customer and service level agreement terms. This information may be needed by an application to service a customer request. To access the information during the processing of a request, the application must make multiple API calls to the CRM application. Additionally, the logic to access the information during the processing of a request must be mixed throughout the logic of the application.

Applications providing services to a client may implement policies to be applied during the processing of a request. Policies are used for a variety of purposes. For instances, polices may be used to authorize or authenticate a user, enforce service level agreements, and allocate resources. One example of a policy management system is the IETF policy management architecture. The IETF architecture includes a policy management service for administering policies and policy enforcement points that enforce policies based on the policy rules. Other exemplary environments that use policies include web service activities (e.g., choreography of events, security), Web-Services-Policy (WS-Policy), Open Mobile Architecture (OMA) activities, and Third Generation Partnership Project (3GPP). In the prior art, policies are implemented as rules having a condition that must be satisfied at the time the condition is evaluated for an action to be executed.

### BRIEF SUMMARY OF THE INVENTION

Methods, systems, and machine-readable mediums are disclosed for managing account-holder information using policies. In one embodiment, a method is disclosed which comprises receiving service agreement information for an account-holder. A policy is generated using the service agreement information. The policy includes a logical combination of one or more conditions and one or more actions related to the service agreement information. In one embodiment, the service agreement enforcement policy may be a policy program object, such as a Business Process Express Language (BPEL) object.

The service agreement enforcement policy may have conditions to evaluate and actions to execute for a variety of different types of service terms. By way of example, the service agreement enforcement policy may include conditions to evaluation and actions to execute for authentication requirements, authorization requirements, service level agreement requirements (e.g., quality of service/prioritization), billing requirements, and/or charging requirements to charge for the service.

The policy may be generated by obtaining terms from the service agreement information and determining sets of one or more conditions and one or more actions associated with each term. For example, the determining the set of conditions/actions associated with a term may include accessing a data storage which maps service agreement terms to sets of conditions/actions The conditions and actions associated with the terms may then be inserted into the policy. In some instances, a set of conditions/actions for a service agreement term may be creating a sub-policy having the conditions/actions set and inserting into the policy an action to invoke the sub-policy.

In some aspects, the policy which is generated using the service agreement information may be a provisioning policy which may be invoked to obtain provisioning information to provision an account associated with the account-holder. Alternatively, the generated policy may be invoked upon the occurrence of an event (e.g., the account-holder makes a request to access a service, account depletion, absence of settlement of bills, or at the occurrence of other types of account-related events). The generated policy may also, in some aspects, be invoked at a scheduled time (e.g., to bill the customer).

In other embodiments, a method is disclosed with comprises receiving a communication from a client to access a service. A policy associated with the client is determined. The policy includes a logical combination of one or more conditions to be satisfied and one or more actions to be executed to enforce the service agreement. The determined policy is then invoked. The method may further comprise receiving a result from the determined policy. If the result indicates the determined policy completed successfully, the communication may be sent to the service.

In still further embodiments, a system that may be used to manage account-holder information using policies is disclosed. The system includes an interface to receive service agreement information for an account-holder. The system also includes account-holder logic to generate a policy using the service agreement information. The policy includes a logical combination of one or more conditions to be satisfied and one or more actions to be executed related to the service agreement information.

In some embodiments, the system may further include a data storage. The data storage includes a plurality of service agreement terms. Each service agreement term is mapped to one or more policy sets. A policy set comprises a logical combination of conditions and actions.

The system may also include a data storage to store account-holder policies. In some aspects, logic may be communicatively coupled with the data storage. The logic may receive a communication from a client to access a service associated with the service agreement. The logic may determine the service agreement enforcement policy associated with the requester and may invoke the determined service agreement enforcement policy. The system may also include the application service, communicatively coupled with the logic, to service the communication if the service agreement enforcement policy completes successfully. In other aspects, the system may further comprise logic to invoke the policy at a scheduled time and/or logic to invoke the policy upon the occurrence of an event associated with the account-holder.

In other embodiments, an account-holder relation management system is disclosed. The account-holder relation management system comprises a data storage including a plurality of policies associated with one or more account-holders. The policies include a logical combination of one or more conditions to be satisfied and one or more actions to be executed to manage the account-holder relationship. The system also includes account-holder management logic, communicatively coupled with the data storage, to enforce the policies. In some aspects, the account-holder management logic may be configured to invoke at least one of the policies upon at least one of account creation, account update, and account removal.

### BRIEF DESCRIPTION OF THE DRAWINGS

Illustrative embodiments in accordance with the invention are illustrated in the drawings in which:

FIG. 1 illustrates an exemplary embodiment of a system that may be used to manage account-holder information using policies;

FIG. 2 illustrate an exemplary embodiment of a policy;

FIG. 3 is a flow diagram of an exemplary method that may be used to manage account-holder information using policies;

FIG. 4 is a flow diagram of actions that may be performed by a provisioning policy;

FIG. 5 illustrates an exemplary embodiment of a system that may use policies created by the system in FIG. 1;

FIG. 6 is a flow diagram illustrating an exemplary method that may be used to service a communication request using a policy;

FIG. 7 illustrates an exemplary execution of a policy having a workflow which executes a plurality of sub-policies;

FIG. 8 is a block diagram of an exemplary computer system upon which a policy enforcement system may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

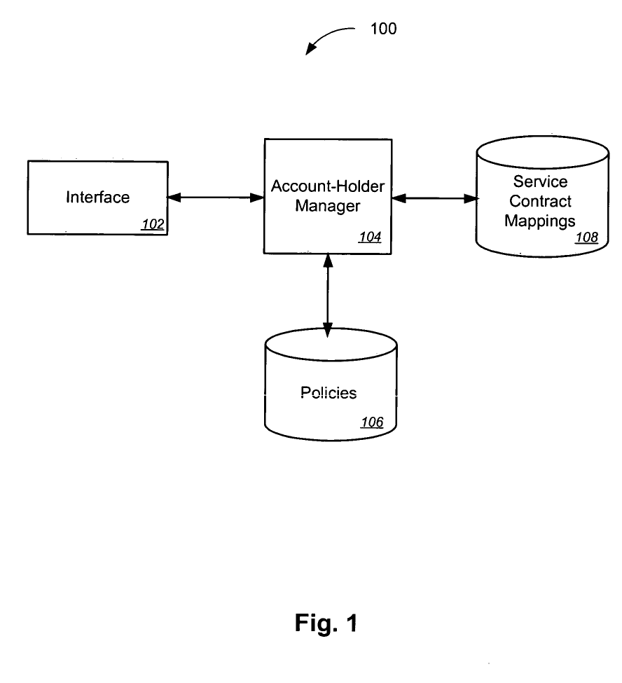

FIG. 1 illustrates an exemplary embodiment of a system that may be used to manage account-holder information using policies. An account-holder may be a customer, subscriber/user, partner, vendor, supplier, or any other person or entity doing business with a company using system 100 to manage account-holder information.

The system 100 includes at least one interface 102. Interface 102 may be any type of interface that may be used to receive service agreement information for account-holders. By way of example, interface 102 may be an application interface to receive information from a client application or a user interface to receive information from a user. The service agreement information may be provided and/or selected by account-holders, may be data collected or entered by an employee or other user acting on behalf of the company using customer information management system 100, and/or may be data collected using any other suitable means.

The account-holder management system 100 further includes account-holder manager 104 communicatively coupled with interface 102. Account-holder manager 104 may be one or more software programs, one or more components of a software program (e.g., function or program object), firmware, or other type of machine-executable instructions that may be used to manage customer information. Account holder manager 104 may be a component of a CRM application, a Partner Relationship Management application, an Enterprise Resource Planning application, or other type of account-relationship management application or solution.

In some embodiments, account-holder manager 104 may be include a workflow engine using Business Process Execution Language (BPEL). As will be described in further detail below, account-holder 104 may be used to generate policies using service agreement information. A generated policy may include a logical combination of conditions to be satisfied and actions to be executed related to a service agreement. In other aspects, account-holder manager 104 may also or alternatively include logic to manage the relation with the account-holder by enforcing policies associated with accounts and/or account-holders. Policies may be enforced at provisioning, request of application services, while providing or at the conclusion of providing application services, at the occurrence of designated events affecting the account or account-holder, at scheduled times, or at any other appropriate time.

Account-holder manager 104 may also be communicatively coupled with one or more data storages 106, 108. Data storages 106, 108 may be relational databases, spreadsheets, text files, internal software lists, or other suitable structure for storing data. One of the data storages 108 may be a service contract mappings data storage 108 which includes a plurality of service agreement terms. Each of the service agreement terms may be mapped to one or more policy sets. A policy set may comprise a logical combination of one or more conditions to be satisfied and/or one or more actions to be executed to enforce the service agreement term associated with the policy set. Account-holder manager 104 may use the service contract mappings 108 to generate a policy based on one or more terms of a service agreement. In some instances, more complex service agreement terms may require more advanced algorithms to determine the corresponding policy set(s) to be included in a service agreement enforcement policy to enforce the term.

The system 100 also includes a policy data storage 106. In some embodiments, the service contract mappings 108 and the policy data storage 106 may be the same data storage. Policy data storage 106 may be used to store policies generated by account-holder manager 104. As previously described, a policy may include a logical combination of conditions to evaluate and actions to execute related to a service agreement. Policies may be implemented as programs, program components, or other type of machine-executable instructions. In one embodiment, service agreement enforcement policies may be program objects, such as a BPEL object.

A variety of different types of policies related to a service agreement may be generated by account-holder manager 108. For instances, policies may be generated which are invoked to provision an account associated with the account-holder. Policies may also be generated which are invoked upon a predetermined event. Merely by way of example, policies may be invoked upon receipt of a communication to access a service, account depletion, absence of settlement of bills, or other type of event related to the account-holder or affecting the account-holder. Other types of policies related to the terms of a service agreement (e.g., billing, settlement policies) may be invoked at scheduled times.

Some of the generated policies may encapsulate conditions to evaluate and actions to be executed to enforce terms of the service agreement with the account-holder. By way of example, a service agreement enforcement policy may include conditions to evaluate and actions to execute to enforce authentication, authorization, service level agreements (prioritization, quality of service, etc.), charging for the service, billing, settlement, and/or other service agreement terms.

In the configuration described above, different components were described as being communicatively coupled to other components. A communicative coupling is a coupling that allows communication between the components. This coupling may be by means of a bus, cable, network, wireless mechanism, program code call (e.g., modular or procedural call) or other mechanism that allows communication between the components. Thus, it should be appreciated that interface 102, customer manager 104, service contract mappings data storage 108, and policies data storage 106 may reside on the same or different physical devices. Additionally, it should be appreciated that the system 100 may contain additional or fewer components that that described in FIG. 1.

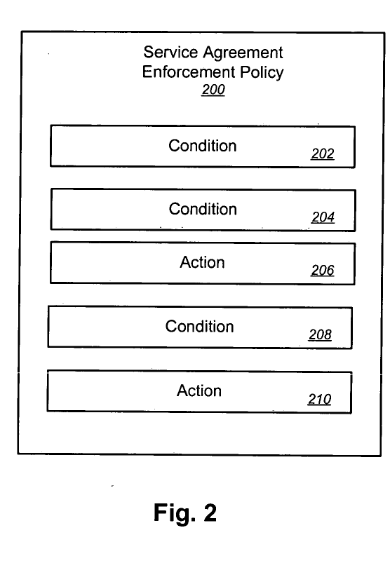

FIG. 2 illustrates an exemplary embodiment of a policy 200. The policy 200 may be associated with an account-holder and may include conditions 202, 204, 208 to be satisfied and actions 206, 210 to be executed related to a service agreement with the account-holder. These conditions 202, 204, 208 and actions 206, 210 may be related to any type of term in a service agreement. By way of example, the policy 200 may enforce terms in the service agreement, such as authentication terms, authorization terms, billing/charging terms, service level terms, logging terms, or any other type of service agreement term. As another example, the policy 200 may include conditions and actions to provision an account based on terms of a service agreement.

Conditions 202, 204, 208 may be logically combined with the actions 206, 210 in a variety of different ways. For instance, policy 200 may include logic which specifies that conditions 202, 204 must be satisfied and action 206 must be executed for the policy 200 to be validated, or that condition 208 must be satisfied and action 210 must be executed for the policy to be validated. If neither combination is successful, then the policy 200 may fail validation. In some instances, a condition 202, 204, 208 that is not satisfied may be re-evaluated after an action 206, 210 has been executed. Alternately, policy 200 may include optional actions that are not required to be executed to validate the policy, but may be executed in the event a condition 202, 204, 208 is not satisfied. The condition 202, 204, 208 may then be re-evaluated after the execution of the optional action(s). In alternate embodiments, conditions 202, 204, 208 and actions 206, 210 may be combined in a different manner than that described.

It should be appreciated that policy 200 includes logic that controls the traversing of conditions and actions. The logic may be a machine-executable program, such as a compiled, interpreted, script, or declarative program language. It should also be appreciated that policy 200 may also include fewer or additional conditions 202, 204, 206 and actions 206, 210 than that shown in FIG. 2.

In some embodiments, one or more sub-policies may be associated with the policy 200. For instances, an authentication sub-policy may include conditions to be satisfied and actions to be executed to satisfy an authentication term in a service agreement. Thus, one or more of the actions 206, 210 may be actions to invoke sub-policies which may need to be validated for the policy 200 to be validated.

It should he appreciated that policy 200 may provide a much more flexible approach to policy implementation than prior solutions. In the prior art, policies are implemented as conditions that must be satisfied when evaluated. Thus, if the policy condition is not satisfied, the policy is not applied. In contrast, policy 200 may include any logical combination of conditions 202, 204, 208 and actions 206, 210. By defining a policy 200 as a logical combination of conditions 202, 204, 208 to be satisfied and actions 206, 210 to be executed, policy enforcement may be more dynamic than previous techniques have allowed. For instance, policy 200 may specify that an action 206 be performed before a condition 208 is evaluated for satisfaction. As another example, policy 200 may specify optional actions that are to be executed only in the event a condition is or is not satisfied.

As previously described, in one embodiment, policies may be implemented as a program object, such as a BPEL object. The policies may be invoked as part of a workflow, such as a BPEL workflow engine. Service agreement enforcement policy 200 may have both a public and a private interface. The public interface may define parameters that may be passed to the service agreement enforcement policy 200 to be used during the policy evaluation. For instance, terms and conditions related to an authentication term may require a security token parameter. The public interface may also include public functions of service agreement enforcement policy 200. Service agreement enforcement policy 200 may also include a private interface. Thus, in some embodiments, service agreement enforcement policy 200 may be a “black box” policy, in which the conditions that are evaluated for satisfaction and the actions executed are in a private interface and not know to the logic responsible for processing communications. Further details of policy enforcement are described in U.S. patent application Ser. No. 11/024,160 entitled “Policies as Workflows”, filed on Dec. 27, 2004, the details of which are hereby incorporated by reference.

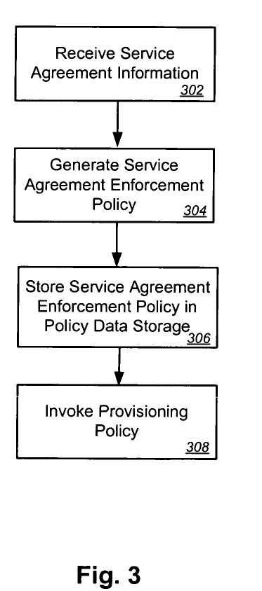

FIG. 3 illustrates an exemplary method that may be used to manage account-holder information using policies. The method may begin by receiving 302 service agreement information for an account-holder. For example, the service agreement information may be received 302 when an account-holder creates an account or signs a service agreement contract or when an account is updated (services added/removed). The service agreement information may include one or more terms related to a service agreement between the account-holder and an application or service provider. These terms may include terms related to authentication requirements for the customer to use the application/service, authorization terms governing which services the customer may use, billing terms specifying the rates the customer will be charged for accessing or using services, logging terms specifying transactions/conditions/events that will generate logs, service level agreements specifying the service guarantees or prioritization for transactions, or other types of terms defining the business relationship with the customer. The service agreement information may be received 302 in any convenient manner. For example, the information may be received from a user interface (e.g., an application GUI or web interface) that a customer or a company representative uses to enter service agreement information, the information may be received from an application, or may be received from a database.

A policy is then generated 304 using the service agreement information. As previously described, the policy may include a logical combination of conditions to be satisfied and actions to be executed related to the terms of the service agreement. The policy may be generated 304 by parsing the service agreement information for terms. Each term may be associated with a logical combination of conditions to be satisfied and actions to be executed related to the term (also referred to herein as a policy set). The association may be determined by retrieving information from a data storage including mappings of possible terms that may be in the service agreement to corresponding sets of conditions and actions. Algorithms may be applied to more complex terms to determine the conditions/actions to be included in the policy to enforce the terms. In some embodiments, the generation 304 of a policy may itself be accomplished by invoking a generate policy including conditions to be satisfied and actions to be executed in order to generate or update policy or policies related to the terms of a service agreement.

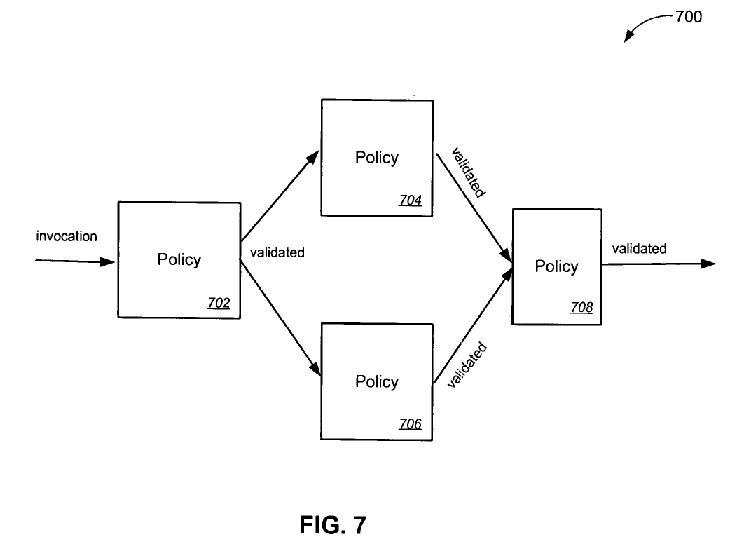

The logical combination of conditions and actions associated with service agreement terms may be inserted into the policy. Alternately or additionally, sub-policies may be generated for one or more terms (e.g., authentication sub-policy, authorization sub-policy, etc.) and actions may be inserted into the policy to invoke the sub-policies. As will be described in more detail with reference to FIG. 7, in some embodiments, the policy may include a workflow, such as a BPEL workflow that executes actions to invoke the sub-policies associated with the policy.

After the policy is generated 304, it may be stored 306 in a data storage. Sub-policies, if used, may also be stored 304 in the data storage. The policy (and any sub policies) may then be invoked by an application/service during processing of a communication to enforce the terms of the service agreement. Alternatively, the policy (and any sub polices) may be invoked at scheduled times, or upon the occurrence of other types of events associated with the account-holder or affecting the account-holder (e.g., depletion of account balance, absence of settlement, etc.). In still further aspects, the policy may be a provisioning policy and may be invoked to provision account(s) associated with the account holder. It should be appreciated that policies may be retrieved and updated if update information for the service agreement is received.

The method may continue by invoking 308 a provisioning policy to obtain provisioning information for the service agreement. The provisioning policy may include a combination of conditions to evaluate and actions to be executed to obtain provisioning information (i.e., information needed to enforce the service agreement terms). As previously described, in some aspects, the provisioning policy may be generated by evaluating the service agreement information to determine information that needs to be obtained to enforce the service agreement terms. In some aspects, a provisioning policy may also schedule future policy enforcement for an account. Merely by way of example, the provisioning policy may schedule billing policies or other types of policies to be invoked at a scheduled time. In alternative embodiments, a provisioning policy may not be invoked 308.

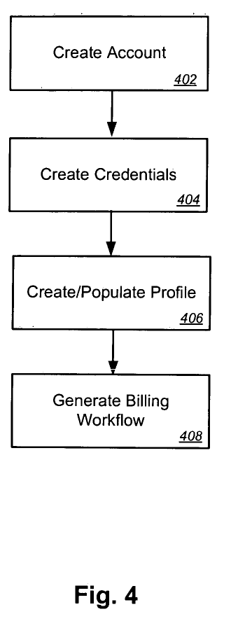

FIG. 4 illustrates exemplary actions that may be performed by a provisioning policy. In some embodiments, the actions may be executed as part of a workflow, such as a BPEL workflow.

The provisioning policy may include one or more actions to create 402 an account associated with an account-holder. The account created 402 may be a record in a data storage structure containing account-holder information related to the account. Credentials, such as security tokens and/or certificates may also be created 404 by the provisioning policy to enforce authentication terms. A profile having account-holder preferences may also be created 406 and populated.

The provisioning policy may, in some aspects, perform actions to generate 408 a billing workflow to bill the customer as specified in the service agreement (e.g., one month cycle, etc). Alternatively, the provisioning policy may schedule future policy enforcements, such as the future invocation of a billing policy or other types of policies.

It should be appreciated that a provisioning policy may also perform additional, fewer, or alternate actions that that described depending upon the information needed to enforce the terms of a service agreement. It should also be appreciated that a provisioning policy may include conditions to evaluate (not illustrated) to determine what information to obtain to provision an account and/or conditions associated with the scheduling of policies.

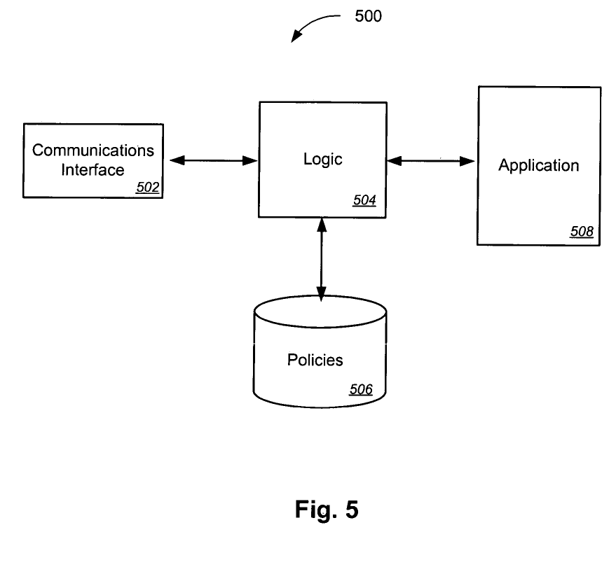

FIG. 5 illustrates an exemplary embodiment of a system that may use service agreement enforcement policies created by the system in FIG. 1. The system 500 includes a communications interface 502. In one embodiment, communications interface 502 may be an interface that may be used to send and receive Internet communications, such as web services communications (e.g., SOAP messages). Communication interface 502 may also be used to receive any type of communications to which policies are applied. Merely by way of example, communications interface may receive communications requesting services, notifications of events from other systems (e.g., account depletion, fraud alert, rejected credit card, canceled account, etc.), communications processed by a service, or any other type of communication to which policies are to be applied.

The system 500 further includes logic 504 communicatively coupled with communications interface 502. Logic 504 may be one or more software programs, one or more components of a software program (e.g., function or program object), firmware, or other type of machine-executable instructions that may be used to process communications received from communications interface 502. In one embodiment, logic 104 may include a workflow engine using Business Process Execution Language (BPEL).

Logic 504 is also communicatively coupled with a policy data storage 506. Policy data storage 506 may be used to store service agreement policies for account-holders. As previously described, service agreement policies may be generated for account-holders by account-holder manager 104 based on information in service agreements. Logic 504 may invoke polices at scheduled times or upon the occurrence of events (e.g., any of the types of events previously described or any other events associated with an account-holder or affecting an account-holder).

Merely by way of example, logic 504 may process communications requests received on communications interface 502 to access application services. During the processing of a communication request, logic 504 may use the policy data storage 506 to determine a service agreement policy associated with the requester. Logic 504 may then invoke a service agreement policy to enforce the terms of the service agreement on the communication. If the policy completes successfully, the communication may then be transmitted to the application 508.

The system 500 further includes an application 508, which is communicatively coupled with logic 504. Communications received on communication interface 502 may be requests to access or use one or more services provided by application 508. Logic 504 may act as a gateway or proxy to application 508 and receive, intercept, or otherwise monitor communications to application 508 so that the terms of a service agreement may be enforced. It should be appreciated that logic 504 may be a standalone application executing on the same or different machine as application 508 or may be a component of application 508.

In one embodiment, application 508 may be a message delivery system and logic 504 may be a proxy or gateway to the message delivery system. A client requester may use the message delivery system to deliver a message to a user device. The client requester may transmit a communication (e.g., a SOAP message) to the message delivery system requesting delivery of a message to a user. In one embodiment, the message may be a web services message (e.g., a SOAP message). Logic 504 may act as a gateway or proxy to the message delivery system and may intercept the message transmitted by the client. Logic 504 may then determine a service agreement enforcement policy associated with the communication requester and may then may then invoke the service agreement enforcement policy. If a result of the execution of the service agreement enforcement policy indicates the policy completed successfully, the communication may then be transmitted to the message delivery system.

Message delivery system may then be used to transmit the message to a user. In one embodiment, message delivery system may enable communication between devices of various users and may be configured to perform automatic device selection and content conversion of messages. Before sending the message to a user, message delivery system may determines devices associated with the recipient. For instances, a user may be associated with an email device 322, a SMS device 324, an Instant Messaging (IM) device, or other type of device that may be used to receive a message. In some instances, a single device may communicate using multiple communication types. Message delivery system may select one or more of the associated devices based on a variety of criteria, such as the message context and user preferences. Message delivery system may convert the message to a format associated with the selected one or more devices and the message may be forwarded to the selected devices. Further details of a message delivery system according to one embodiment may be found in application Ser. No. 10/684,686 filed Oct. 13, 2003, entitled “Instant Messaging”, the details of which are hereby incorporated by reference. It should be appreciated that other types of applications may also use logic 504 to enforce the terms of service agreements using service agreement enforcement policies. It should also be appreciated that logic 504 may invoke other types of policies associated with service agreements, either upon the occurrence of events or at scheduled times.

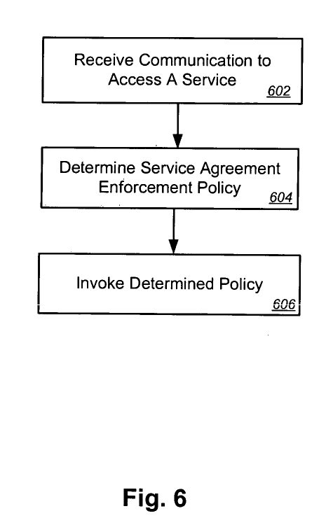

FIG. 6 illustrates an exemplary method that may be used to enforce a policy on a communication requesting application services. The method may begin by receiving 602 a communication, such as a SOAP message, from a requester to access or use one or more services provided by an application. A service agreement enforcement policy associated with the requester is determined 604. In one embodiment, a policy data storage may be accessed to determine a service agreement enforcement policy associated with the requester. In some instances, the service agreement enforcement policy may be associated with one or more sub-policies, which may also be retrieved from a policy data storage.

The service agreement enforcement policy to be applied to the communication is then invoked 606. By way of example, the service agreement enforcement policy may be invoked 606 by making a program call to a function, object, or other program. For instances, the policy may be a BPEL policy which is invoked by executing a statement in the format <invoke policy=“policy id”>. Parameters may also be specified in the invocation call.

A result of the service agreement enforcement policy may then be received. If the result indicates the service agreement enforcement policy completed successfully, the service agreement enforcement policy may be considered validated and the communication may be transmitted to the application for processing. If not, a denial or other error message may be transmitted to the requester. In some cases, before transmitting a denial of the request, an attempt may first be made to recover from any errors of the policy execution. For instances, program code specified in a fault handler may be executed.

FIG. 7 illustrates an exemplary embodiment of an execution of a service agreement policy 700. In this embodiment, the service agreement policy includes a workflow (e.g., a BPEL workflow engine) or other type of logic which performs actions to invoke a plurality of sub-policies 702, 704, 706, 708 associated with terms of a service agreement. These sub-policies may include a logical combination of conditions to evaluate and actions to execute to enforce terms of the service agreement. The sub-policies may be used to logically group terms of a service agreement into various functions, such as authentication, authorization, logging, prioritization, and charging.

If a sub-policy 702 completes successfully, it is validated and other sub-policies may 704, 706, 708 may then be invoked. In some embodiments, in the event a sub-policy 702, 704, 706, 708 does not complete successfully, error recovery may be applied. For example, a BPEL fault handler may specify actions that occur if a sub-policy 702, 704, 706, 708 fails to complete successfully. In some cases, sub-policies 704, 706 may be invoked and at least partially execute simultaneously (e.g., by invoking the sub-policies 704, 706 as part of a BPEL flow).

It should be appreciated that service agreement policy 700 may include other actions and/or conditions to evaluate. For instance, conditions may be evaluated to determine which sub-policies to invoke. After all of the sub-policies 702, 704, 706, 708 have been validated, any other actions have completed successfully, and any conditions to be satisfied have evaluated successfully, service agreement enforcement 700 may return a result indicating the policy evaluation (execution) completed successfully. In alternate embodiments, additional or fewer sub-polices may be invoked in a service agreement policy and/or the sub-policies may be invoked in a different type of workflow than illustrated in FIG. 7.

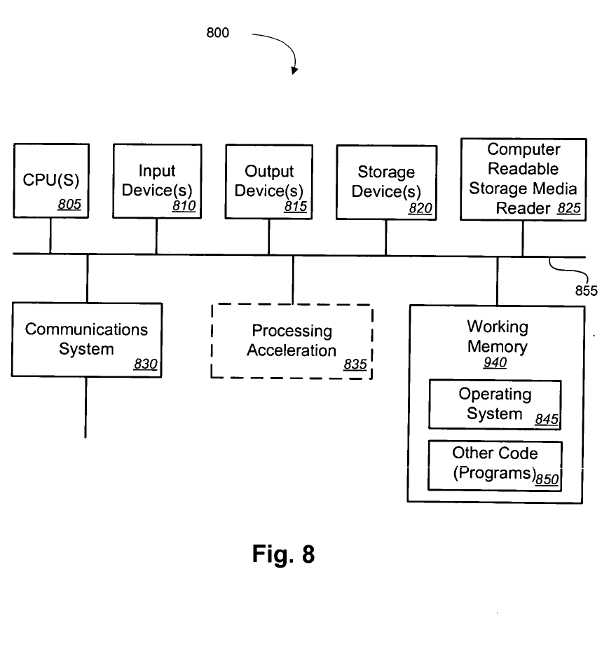

FIG. 8 illustrates one embodiment of a computer system 800 upon which a policy enforcement system or components of a policy enforcement system may be implemented. The computer system 800 is shown comprising hardware elements that may be electrically coupled via a bus 855. The hardware elements may include one or more central processing units (CPUs) 805; one or more input devices 810 (e.g., a mouse, a keyboard, etc.); and one or more output devices 815 (e.g., a display device, a printer, etc.). The computer system 800 may also include one or more storage device 820. By way of example, storage device(s) 820 may be disk drives, optical storage devices, solid-state storage device such as a random access memory (“RAM”) and/or a read-only memory (“ROM”), which can be programmable, flash-updateable and/or the like.

The computer system 800 may additionally include a computer-readable storage media reader 825; a communications system 830 (e.g., a modem, a network card (wireless or wired), an infra-red communication device, etc.); and working memory 840, which may include RAM and ROM devices as described above. In some embodiments, the computer system 800 may also include a processing acceleration unit 835, which can include a DSP, a special-purpose processor and/or the like.

The computer-readable storage media reader 825 can further be connected to a computer-readable storage medium, together (and, optionally, in combination with storage device(s) 820) comprehensively representing remote, local, fixed, and/or removable storage devices plus storage media for temporarily and/or more permanently containing computer-readable information. The communications system 830 may permit data to be exchanged with a network and/or any other computer.

The computer system 800 may also comprise software elements, shown as being currently located within a working memory 840, including an operating system 845 and/or other code 850, such as an application program. The application programs may implement a policy enforcement system, components of a policy enforcement system, and/or the methods of the invention. It should be appreciate that alternate embodiments of a computer system 800 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. Additionally, the methods may contain additional or fewer steps than described above. It should also be appreciated that the methods described above may be performed by hardware components or may be embodied in sequences of machine-executable instructions, which may be used to cause a machine, such as a general-purpose or special-purpose processor or logic circuits programmed with the instructions, to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method comprising:
receiving service agreement information for an account-holder; and
generating a policy using the service agreement information, the policy including a logical combination of one or more conditions to be satisfied and one or more actions to be executed related to the service agreement information.

2. The method of claim 1, wherein generating the policy comprises:
obtaining a first term from the service agreement information; and
determining a first set of at least one of one or more conditions and one or more actions associated with the first term.

3. The method of claim 2, further comprising inserting the first set into the policy.

4. The method of claim 2, further comprising:
creating a sub-policy including the first set; and
inserting an action in the policy to invoke the sub-policy.

5. The method of claim 2, further comprising for at least one additional term included in the service agreement information, determining an additional set of at least one of one or more conditions and one or more actions associated with the additional term.

6. The method of claim 2, wherein determining the first set comprises accessing a data storage mapping service agreement terms to one or more policy sets, each policy set having a logical combination of at least one of one or more conditions and one or more actions.

7. The method of claim 1, wherein generating the policy comprises:
generating one or more sub-policies; and
inserting a workflow into the policy, the workflow invoking the one or more sub-policies.

8. The method of claim 1, wherein generating the policy comprises invoking a generate policy, the generate policy including a logical combination of one or more conditions to be satisfied and one or more actions to be executed to generate the policy.

9. The method of claim 1, further comprising:
receiving a communication request for an application service from the account-holder;
determining the policy is associated with the account-holder; and
invoking the policy.

10. The method of claim 1, wherein the service agreement information includes an authentication requirement, and wherein generating the policy comprises inserting at least one of one or more conditions to evaluate and one or more actions to execute to enforce the authentication requirement.

11. The method of claim 1, wherein the service agreement information includes an authorization requirement, and wherein generating the policy comprises inserting at least one of one or more conditions to evaluate and one or more actions to execute to enforce the authorization requirement.

12. The method of claim 1, wherein the service agreement information includes a service level agreement, and wherein generating the policy comprises inserting at least one of one or more conditions to evaluate and one or more actions to execute to enforce the service level agreement.

13. The method of claim 1, wherein the service agreement includes a charging agreement to charge for application services, and wherein generating the policy comprises inserting at least one of one or more conditions to evaluate and one or more actions to execute to enforce the charging agreement.

14. The method of claim 1, further comprising:
receiving an update to the service information; and
updating the policy.

15. The method of claim 1, wherein generating the policy comprises generating a provisioning policy, the provisioning policy having a logical combination of at least one condition to be satisfied and at least one action to be executed to obtain provisioning information to provision an account associated with the account-holder, the method further comprising:
receiving a communication to provision the account;
determining the provisioning policy is associated with the account; and
invoking the provisioning policy.

16. The method of claim 1, further comprising at a scheduled time, invoking the policy.

17. The method of claim 1, wherein generating the policy comprises generating a policy program object.

18. A method comprising:
receiving, from a requester, a communication to access a service;
determining a service agreement enforcement policy associated with the requester, the policy including a logical combination of one or more conditions to be satisfied and one or more actions to be executed to enforce a service agreement; and
invoking the determined policy.

19. The method of claim 18, further comprising receiving a result from the determined policy.

20. The method of claim 19, further comprising if the result indicates the determined policy completed successfully, sending the communication to the service.

21. The method of claim 18, wherein the service comprises a message delivery service and the communication is a message for a user.

22. A system comprising:
a interface to receive service agreement information for an account-holder; and
account-holder management logic to generate a policy using the service agreement information, the policy including a logical combination of one or more conditions to be satisfied and one or more actions to be executed related to the service agreement information.

23. The system of claim 22, further comprising a data storage including a plurality of service agreement terms, each service agreement term mapped to one or more policy sets, the policy sets comprising a logical combination of at least one of one or more conditions and one or more actions.

24. The system of claim 22, further comprising a data storage to store the policy.

25. The system of claim 24, further comprising logic, communicatively coupled with the data storage, to receive a communication from a requester to access a service associated with the service agreement, and to determine the policy is associated with the requester, and to invoke the policy.

26. The system of claim 24, further comprising logic, communicatively coupled with the data storage, to receive a communication from a requester to access a service associated with the service agreement, to determine the policy is associated with the requester, and to invoke the policy.

27. The system of claim 22, further comprising logic to invoke the policy at one of a scheduled time, upon the occurrence of an event associated with the account-holder or upon an event related to an account associated with the account-holder.

28. At least one machine-readable medium, having stored thereon sequences of instructions, which, when executed by a machine cause the machine to:
receive service agreement information for an account-holder; and
generate a policy using the service agreement information, the policy including a logical combination of one or more conditions to be satisfied and one or more actions to be executed related to the service agreement information.

29. An account-holder relation management system comprising:
a data storage including a plurality of policies associated with one or more account-holders, the policies including a logical combination of one or more conditions to be satisfied and one or more actions to be executed to manage the account-holder relationship;
account-holder management logic, communicatively coupled with the data storage, configured to enforce the policies.

30. The system of claim 29, wherein the account-holder management logic is to invoke at least one of the policies upon at least one of account creation, account update, and account removal.
